(19) United States
(12) Patent Application Publication
(10) Pub. No.: US 2004/0064956 A1
(43) Pub. Date: Apr. 8, 2004

(54) Grip of a letter knife

(76) Inventor: Ching Tsung Tsai, Ho Mei (TW)

Correspondence Address: TROXELL LAW OFFICE PLLC, SUITE 1404, 5205 LEESBURG PIKE, FALLS CHURCH, VA, 22041, US

(21) Appl. No.: 10/265,379

(22) Filed: Oct. 7, 2002

(51) Int. Cl. B26B 3/00; B25G 1/12; B25G 3/00

(52) U.S. Cl. 30/342; 30/314; 30/340

(57) ABSTRACT

The grip of a letter knife is formed at the rear end of a knife body and fitted around with a grip sleeve, which is a hollow tubular foamed body. The grip sleeve can prevent a user's hand from slipping off of a user's hand, preventing also the grip of a letter knife from rusting or eroding and let a user feel comfortable in holding, and is able to be replaced with a new one easily.

### BACKRROUND OF THE INVENTION

This invention relates to the grip of a letter knife, particularly to one able to be held with comfort, impossible to slip off in operating and safe in use.

A conventional letter knife 1, as shown in FIG. 1, is formed with a knife body 2 with a flat, narrow and elongate profile. The knife body 2 is formed with a cutting edge 3 at one side for cutting open a letter and a grip 4 made integral at the rear end of the knife body for a user to hold thereon for operating. The conventional letter knife 1 can also have its grip 4 sandwiched and tightly between two wooden boards 5 or two plastic boards to make up a wooden or a plastic grip after fastened together so as to increase its thickness.

Generally, after the conventional letter knife 1 including its knife body 2 and its grip 4 are integrally compression molded, it has to be trimmed and polished, and then has its surface electroplated with a metallic layer to increase smoothness and brightness.

However, the conventional letter knife 1 has the following defects.

1. The letter knife 1 is provided with a hang hole 6 to be hung up to let the letter knife 1 soak in electroplating liquid for electroplating, but the inner wall of the hang hole 6 and its abutting surface blocked by a hang hook can hardly be electroplated completely with a metallic layer, resulting in imperfection of products and lowering their quality.

2. The grip 4 of the conventional letter knife 1 is made of hard metal or covered by hard wooden boards, therefore a user always has a feeling of discomfort in holding the grip 4 to cut open a letter, and it is even liable to cause an ache in the palm of the user.

3. The surface of the grip 4 is smooth, therefore when holding it and applying force to cut open a letter, the user's hand is likely to slip off and also easy to sweet. As a result, such salty sweat of the user's hand may erode the electroplated layer of the grip 4 after the grip 4 is employed for a period of time.

4. The conventional letter knife 1 is a metal plate by compression molding, therefore if its peripheral hairy edge is not completely cleaned out, it is liable to scrape and hurt the hand of a user.

5. If the grip 4 is covered with wooden boards 5, it is possible to prevent a user's hand from being scraped and hurt by the hairy edge of the grip 4, but it increases cost in material and assembly.

### SUMMARY OF THE INVENTION

This invention is devised to offer the grip of a letter knife, covered up with a grip sleeve having flexibility and frictional force to be held comfortably and safely, possible to prevent the grip from eroding, and able to be replaced with a new one.

### BRIEF DESCRIPTION OF DRAWINGS

This invention will be better understood by referring to the accompanying drawings, wherein:

FIG. 1 is a perspective view of a conventional letter knife:

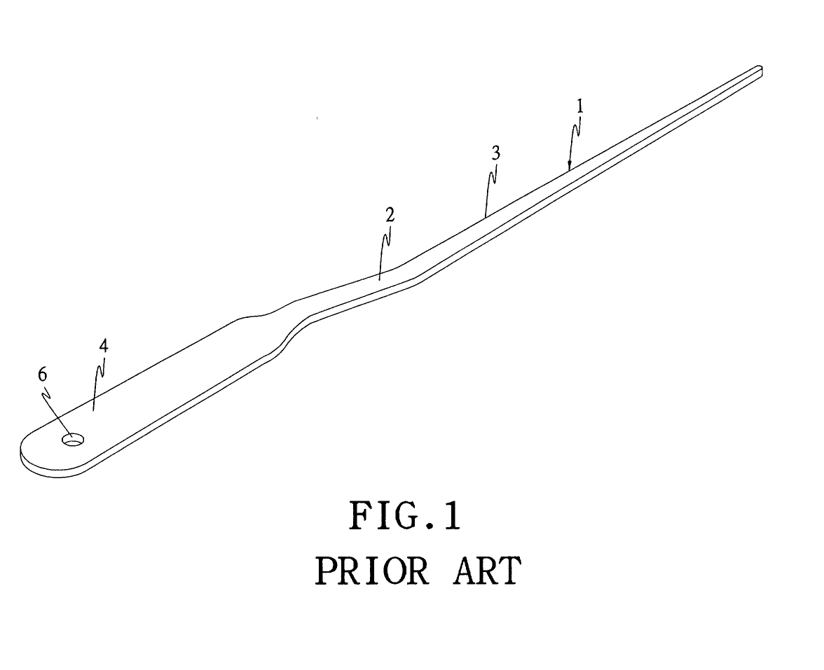

FIG. 2 is a perspective view of another conventional letter knife:

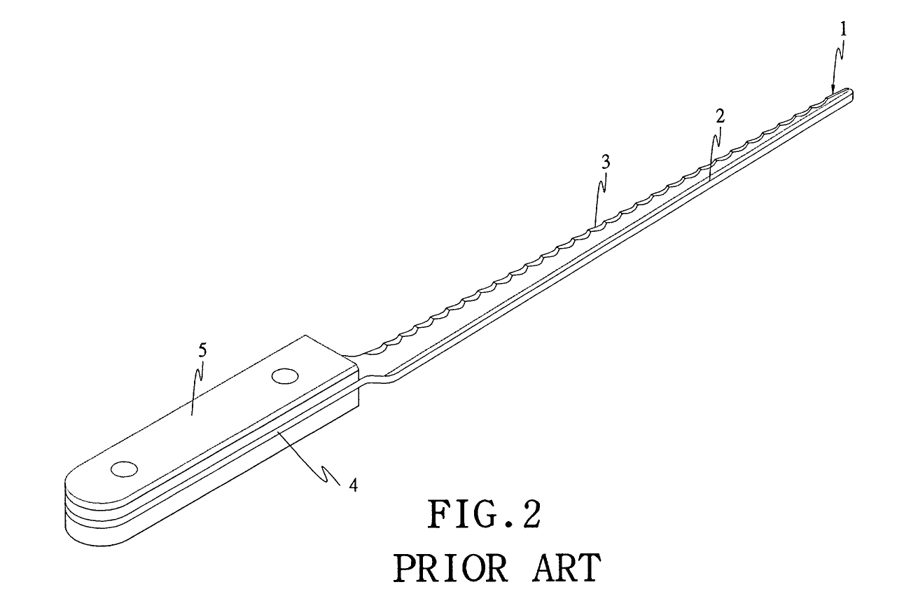

FIG. 3 is an exploded perspective view of a first embodiment of a letter knife in the present invention:

FIG. 4 is a cross-sectional view of the first embodiment of the letter knife in the present invention:

FIG. 5 is an exploded perspective view of a second embodiment of a letter knife in the present invention:

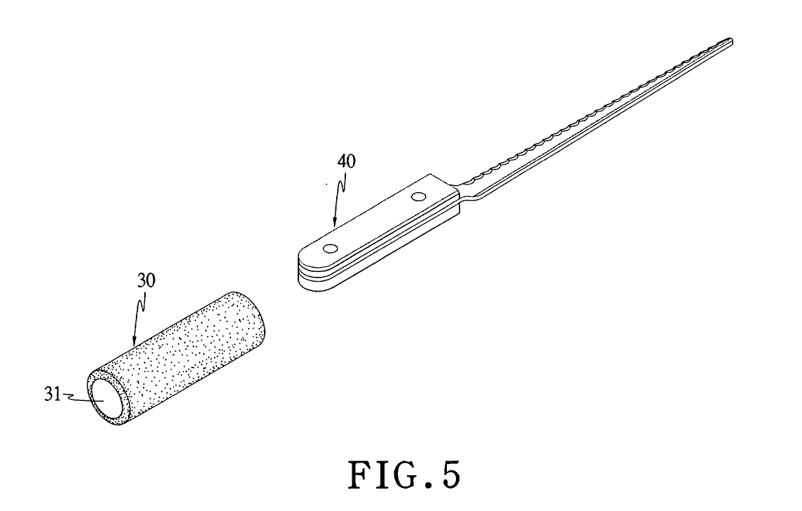

FIG. 6 is a perspective view of a third embodiment of a grip sleeve in the present invention: and

FIG. 7 is a perspective view of a fourth embodiment of a grip sleeve in the present invention.

### DETAILED DESCRIPTION OF THE PREFERRED EMBODIMENT

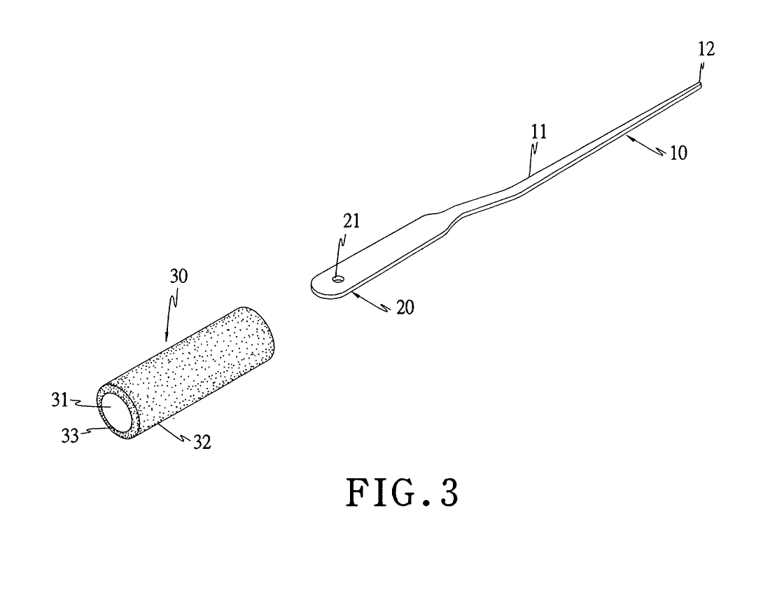

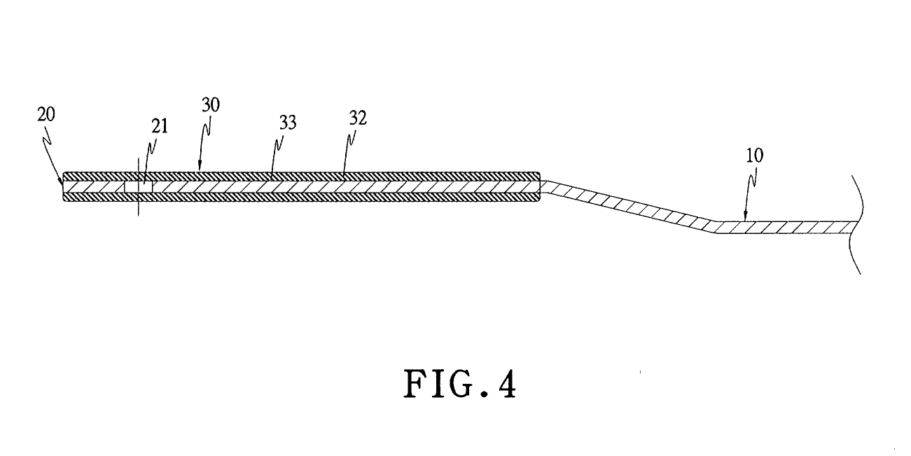

A first preferred embodiment of a letter knife in the present invention, as shown in FIGS. 3 and 4, includes a knife body 10, a grip 20 and a grip sleeve 30 combined together.

The knife body 10 is made of metal, formed with a cutting edge 11 at one side and a knife tip 12 at the front end.

The grip 20 is made integral at the rear end of the knife body 10, having a narrow and elongate shape and provided with a round hole 21 near the rear end.

The grip sleeve 30 to be fitted around the grip 20 is a hollow cylinder-shaped PU foamed body made integral, having an axial fit hole 31 in the center. The grip sleeve 30 has its outer circumference formed into a holding surface 32 with a small foam density, and the fit hole 31 has its inner wall formed into a slip-preventive surface 33 with a large foam density, so that when fitted around the surface of the grip 20, the slip-preventive surface 33 can be stably contact the grip 20.

A second preferred embodiment of the grip 20 of a letter knife in the present invention is to have the grip 20 sandwiched firmly between two wooden boards 40 and then covered thereon with a grip sleeve 30. The grip sleeve 30 has contractile resilience, so its fit hole 31 can be easily expanded and fitted around the wooden boards 40.

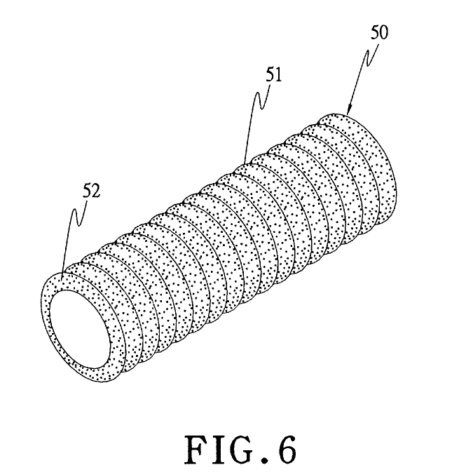

A third preferred embodiment of a grip sleeve 50 in the present invention shown in FIG. 6 is to have its holding surface 51 formed into regularly corrugated grains 52 so as to avoid slipping in holding.

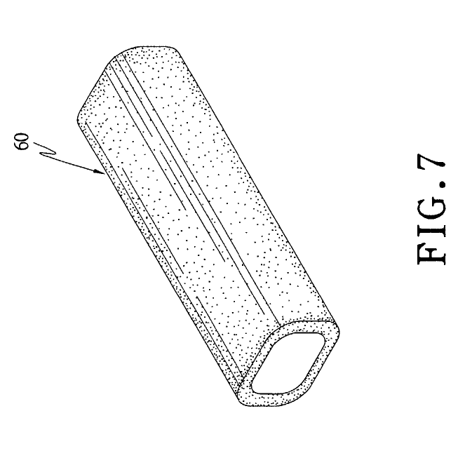

A fourth preferred embodiment of a grip sleeve 60 in the present invention shown in FIG. 7 is to have its profile formed into a hollow rectangular body to be fitted around the same shaped grip of a letter knife.

Specifically, the grip sleeve 30 has its holding surface 32 formed with a fine rough surface to increase a frictional force to avoid slipping off in holding. Besides, the grip sleeve 30 is elastic and soft, so it has a function of protecting a user's hand from being wrenched in operating.

Further, the fit hole 31 of the grip sleeve 30 has its inner wall formed with a slip-preventive surface 33 with a large foam density, therefore it has a large friction force to contact tightly the surface of any grip 20 made of different materials. Besides, this grip sleeve 30 conceals the imperfect parts of the round hole 21 of the grip 20 after electroplated, having an additional value.

Furthermore, the grip sleeve 30 separates a user's sweaty hand from the grip 20, preventing the electroplated surface of the grip 20 from rusting and peeling off. Besides, the grip sleeve 30 can easily be replaced with a new one.

To sum up, this invention has the following advantages.

1. The grip sleeve 30 is made of resilient PU foamed body, so it increases frictional force and flexibility of holding, enabling a user's fingers to apply strength conveniently and preventing hand joints from being wrenched.

2. The imperfection around the periphery of the round hole 21 of a letter knife, caused in the process of electroplating, can be concealed by the grip sleeve 30, increasing the additional value of products.

3. The grip sleeve 30 is flexible and can be of varied shapes, so it is applicable to any grip 20 of different shapes, having extensive adaptability in use.

4. The grip sleeve 30 can effectively protect a metal grip 20 from rusting and eroding, and it can also be employed as a protective article to cover up a rare letter knife, elevating competitive force of products.

5. The holding surface 32 of the grip sleeve 30 can be designed with preset shapes or colors, so a user can optionally purchase a style he likes.

While the preferred embodiments of the invention have been described above, it will be recognized and understood that various modifications may be made therein and the appended claims are intended to cover all such modifications that may fall within the spirit and scope of the invention.

I claim:

1. A letter knife comprising a knife body and a grip, said knife body formed with a cutting edge and a knife tip for cutting open a seated letter: and,
Characterized by a grip sleeve fitted around said grip, said grip sleeve being a hollow cylindrical foamed body made integral, said grip sleeve formed with an axial fit hole in the center, said axial fit hole fitted firmly around said grip.

2. The grip of a letter knife as claimed in claim 1, wherein said grip sleeve has its outer periphery formed into a holding surface with a small foam density, and the inner wall of said fit hole formed into a slip-preventive surface with a large foam density to enable said grip sleeve to contact firmly said grip when it covers up the surface of said grip.

3. The grip of a letter knife as claimed in claim 1, wherein said grip sleeve is cylinder-shaped.

4. The grip of a letter knife as claimed in claim 1, wherein said grip sleeve is a hollow cuboid.

5. The grip of a letter knife as claimed in claim 1, wherein said grip sleeve has its holding surface formed into regularly corrugated grains.

6. The grip of a letter knife as claimed in claim 1 wherein said grip sleeve is a PU foamed body.

7. The grip of a letter knife as claimed in claim 1, wherein said grip sleeve can be designed with preset colors.
